(19) United States
(12) Patent Application Publication
(10) Pub. No.: US 2025/0363408 A1
(43) Pub. Date: Nov. 27, 2025

(54) MACHINE LEARNING MODEL TRAINING USING A SELF-TRAINING APPROACH FOR KNOWLEDGE DISTILLATION

(71) Applicant: eBay Inc., San Jose, CA (US)

(72) Inventors: Bracha Leah Shapira, Beer-Sheva (IL); Gilad Eliyahu Fuchs, Kfar-Saba (IL); Alexander Nus, Tenafly, NJ (US)

(21) Appl. No.: 18/672,573

(22) Filed: May 23, 2024

(51) Int. Cl. G06N 20/00

(52) U.S. Cl. CPC G06N 20/00

(57) ABSTRACT

A plurality of data items associated with user-generated content is identified. A first subset of data items in the plurality of data items is annotated using a first machine learning (ML) model. The first ML model is trained based on the first plurality of labels generated for the first subset of data items. The first ML model is used to annotate a second subset of data items in the plurality of data items. A second ML model is trained based on a second plurality of labels generated based on the annotating of the second subset of data items.

### TECHNICAL FIELD

The present disclosure generally relates to data processing using machine learning technologies. More particularly, various embodiments described herein provide for systems, methods, techniques, instruction sequences, and devices that facilitate machine learning model training using a self-training approach for knowledge distillation.

### BACKGROUND

Machine learning models, such as Large Language Models (LLMs), have revolutionized the field of natural language processing with their ability to understand and generate human-like text. These models are trained on vast amounts of data. Deployment of large-size LLMs can lead to high latency and significant computational costs. Additionally, the effectiveness of smaller, more manageable LLMs in production environments is contingent upon the availability of high-quality datasets, which can be resource-intensive to produce. Traditional data labeling processes involve human annotators, which can be time-consuming and expensive. As a result, there is a continuous search for methods to streamline the annotation process while maintaining or improving the quality of the labeled data.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of examples, and not limitations, in the accompanying figures.

FIG. 1 is a block diagram showing an example data system that includes a data management system, according to various embodiments of the present disclosure.

FIG. 2 is a block diagram illustrating an example data management system that facilitates machine learning model training, according to various embodiments of the present disclosure.

FIG. 3 is a flowchart illustrating an example method for facilitating machine learning model training using a cascade of models for knowledge distillation, according to various embodiments of the present disclosure.

FIG. 4 is a flowchart illustrating an example method for facilitating machine learning model training using a cascade of models for knowledge distillation, according to various embodiments of the present disclosure.

FIG. 5 is a flowchart illustrating an example method for facilitating machine learning model training using a self-training approach, according to various embodiments of the present disclosure.

FIG. 6 is a flowchart illustrating an example method for facilitating machine learning model training using a self-training approach, according to various embodiments of the present disclosure.

FIG. 7 is a diagram illustrating data flow within an example data management system that facilitates machine learning model training using the LLM Cascade for Annotation (LCA) and the LLM Self-Training for Annotation (LSTA) approaches, according to various embodiments of the present disclosure.

FIG. 8 is a diagram illustrating a line graph representing model output accuracy in relation to rounds of self-training using the LSTA approach, according to various embodiments of the present disclosure.

FIG. 9 is a diagram illustrating a line graph representing model output accuracy in relation to the size of training samples under the LSTA approach, according to various embodiments of the present disclosure.

FIG. 10 is a diagram illustrating the comparative performance statistics of the LCA and the LSTA approaches, according to various embodiments of the present disclosure.

FIG. 11 is a block diagram illustrating a representative software architecture, which may be used in conjunction with various hardware architectures herein described, according to various embodiments of the present disclosure.

FIG. 12 is a block diagram illustrating components of a machine able to read instructions from a machine storage medium and perform any one or more of the methodologies discussed herein according to various embodiments of the present disclosure.

### DETAILED DESCRIPTION

The description that follows includes systems, methods, techniques, instruction sequences, and computing machine program products that embody illustrative embodiments of the present disclosure. In the following description, for purposes of explanation, numerous specific details are set forth in order to provide a thorough understanding of embodiments. It will be evident, however, to one skilled in the art that the present inventive subject matter may be practiced without these specific details.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various embodiments may be given throughout this description. These are merely descriptions of specific embodiments. The scope or meaning of the claims is not limited to the embodiments given.

Various embodiments include systems, methods, and non-transitory computer-readable media that facilitate machine learning model training using a cascade of models for knowledge distillation, according to various embodiments of the present disclosure. Specifically, the present disclosure involves training machine-learning models (e.g., LLMs) to enhance the data annotation process, particularly for training models that perform classification tasks. Classification tasks in machine learning refer to categorizing data into predefined classes, such as determining whether the sentiment of a product review is positive, negative, or neutral. Leveraging the capabilities of LLMs to generate labeled data is an important step in training accurate and efficient classification models. The concept of employing a larger model for initial data annotation followed by training smaller models is referred to as knowledge distillation, where knowledge is transferred from a larger model (e.g., a teacher model) to a smaller one (e.g., a student model).

Various embodiments discussed in the present disclosure extend knowledge distillation by implementing two efficient approaches for leveraging LLMs of different sizes in the data annotation process tailored for production environments. The first approach refers to LLM Cascade for Annotation (LCA), where a cascade of distillation starts from a large-scale LLM to a medium-scale LLM and finally to a small-scale production-friendly model (e.g., a small-scale LLM). The second approach refers to LLM Self-Training for Annotation (LSTA), where a small-scale production-friendly model is trained to handle classification tasks without involving large-scale LLMs. Instead, a medium-scale LLM is used to leverage self-supervision techniques to generate the training data for the small-scale production-friendly model, ensuring applicability in real-world production settings.

### LLM Cascade for Annotation (LCA)

Given the time and cost constraints of using large-scale LLMs, oftentimes, it is not practical to use them to annotate large datasets. Small-scale models usually require large labeled datasets for efficient and effective fine-tuning. A more practical distillation funnel is evaluated where only a small portion of an unlabeled dataset is annotated using a large-scale LLM. The labeled small portion is used to fine-tune a medium-scale LLM. The generated labels used for training other models are also referred to as pseudo-labels. Such a medium-scale LLM allows relatively fast fine-tuning with commonly used hardware (e.g., 10 minutes for fine-tuning using 500 samples with less than 16 GB GPU RAM usage). The fine-tuned medium-scale LLM is then used to annotate a significant portion (or the remaining portion) of the unlabeled dataset. Finally, the pseudo-labels generated by the fine-tuned medium-scale LLM are used to train a small-scale LLM (e.g., an LLM with approximately 110M parameters), which can be easily used in a production setting.

In various embodiments, a data management system identifies a plurality of data items associated with user-generated content. For example, user-generated content can include one or more data items, such as reviews and comments. The data management system annotates, using a machine learning (ML) model (e.g., the first ML model), a subset of data items (e.g., the first subset of data items) in the plurality of data items. An example of the first ML model can be a large-scale Large Language Model (LLM) with weights of more than 100 billion parameters. The plurality of data items associated with user-generated content can include one or more of a plurality of comments and a plurality of reviews. The operation of annotating the subset of data items can include generating a plurality of labels (e.g., the first plurality of labels) for the subset of data items (e.g., the first subset of data items). Each label can describe a sentiment (e.g., positive, negative, neutral) of user-generated content associated with a respective data item (e.g., a product review or comment). In various embodiments, a sentiment of user-generated content corresponds to a model output value representing positive, negative, or neutral.

In various embodiments, a data management system trains a second ML model based on the first plurality of labels generated for the first subset of data items. The second ML model can be a medium-scale Large Language Model (LLM) with weights between 1 billion parameters and 100 billion parameters. In various embodiments, the data management system annotates, using the second ML model trained based on the first plurality of labels, a second subset of data items in the plurality of data items. The operation of annotating the second subset of data items can include the operation of generating a second plurality of labels for the second subset of data items. Compared to the first subset of data items (e.g., 500 examples), the second subset of data items can include a significant portion (or the remaining portion) of the unlabeled datasets. For example, the significant portion (or the remaining portion) can include 25,000 examples.

In various embodiments, the data management system trains a third ML model based on the second plurality of labels generated by the second ML model. The third ML model can be a small-scale, production-friendly Large Language Model (LLM) having weights of less than 1 billion parameters. An example of the third ML model is Bidirectional Encoder Representations from Transformers (BERT). BERT is a small, production-friendly model that helps avoid significant constraints related to scale and costs.

In various embodiments, the data management system determines a confidence value based on the first plurality of labels generated by the large-scale LLM. The confidence value represents the accuracy of annotation for the first subset of data items. The data management system can train the second ML model and the third ML model based on the confidence value. For example, the accuracy of the annotation (model outputs) for the first subset of data items is determined to be 97%, corresponding to a confidence value of 0.97. It indicates that 97% of labels generated for the first subset of data items are accurately determined. Such a percentage of accuracy can be used as a training goal in the subsequent training of the second and third ML models.

### LLM Self-Training for Annotation (LSTA)

The LLM Self-Training for Annotation (LSTA) approach leverages model's self-training capabilities to generate the training data for small-scale production-friendly models, such as Bidirectional Encoder Representations from Transformers (BERT), without the need to involve large-scale LLMs (e.g., LLMs with weights more than 100 billion parameters). Specifically, pseudo-labels (e.g., labels generated as training data) are generated by a pre-trained medium-scale LLM. Only the pseudo-labels following the instructions given to the model are selected. For example, an instruction to the model is “to annotate the sentiment of a text with a single word-either ‘positive’ or ‘negative.’” Only samples with the model outputs equal to the expected text are selected. These selected pseudo-labels are used to fine-tune the medium-scale LLM in a self-training fashion. Multiple rounds of training may be executed to improve confidence value.

In various embodiments, a data management system identifies a plurality of data items associated with user-generated content. For example, user-generated content can include one or more data items, such as reviews and comments. The data management system annotates, using a machine learning (ML) model (e.g., the first ML model), a subset of data items (e.g., the first subset of data items) in the plurality of data items. An example of the first ML model is a medium-scale Large Language Model (LLM) with weights between 1 billion and 100 billion parameters. The plurality of data items associated with user-generated content can include one or more of a plurality of comments and a plurality of reviews. The operation of annotating the subset of data items can include generating a plurality of labels (e.g., the first plurality of labels) for the subset of data items (e.g., the first subset of data items). Each label can describe a sentiment (e.g., positive, negative, neutral) of user-generated content associated with a respective data item (e.g., a product review or comment). In various embodiments, a sentiment of user-generated content corresponds to a model output value representing positive, negative, or neutral.

In various embodiments, the data management system trains the medium-scale LLM (e.g., the first ML model) based on the first plurality of labels generated for the first subset of data items. This LSTA approach leverages the self-supervision techniques and capabilities of the medium-scale LLM (e.g., the first ML model) to self-train using labels generated by itself.

In various embodiments, the data management system uses the medium-scale LLM trained based on the first plurality of labels generated by itself to annotate a second subset of data items in the plurality of data items. The operation of annotating the second subset of data items includes generating a second plurality of labels for the second subset of data items.

In various embodiments, the data management system trains a small-scale production-friendly model (e.g., the second ML model) based on the second plurality of labels generated for the second subset of data items. The second ML model can be a small-scale, production-friendly LLM with weights of less than 1 billion parameters. An example of the second ML model is Bidirectional Encoder Representations from Transformers (BERT). BERT is a small, production-friendly model that helps avoid significant constraints related to scale and costs.

In various embodiments, the data management system determines a confidence value based on a plurality of example labels generated by a large-scale large language model with weights of more than 100 billion parameters. Based on the confidence value, the system determines (or configures) the model output probability.

In various embodiments, the data management system identifies one or more confidence labels from the first plurality of labels based on the determined model output probability. The data management system then trains the medium-scale LLM (e.g., the first ML model) based on the one or more confidence labels associated with user-generated content. This approach improves the labeling quality by selecting high-confidence labels based on the model output probabilities. Those selected high-confidence pseudo-labels (>0.9) generated by the medium-scale LLM are used to fine-tune the model itself. This self-training process can be repeated as needed. The self-trained medium-scale LLM is then used to generate the final pseudo-labels to train the small-scale production-friendly model (e.g., the second ML model).

Reference will now be made in detail to embodiments of the present disclosure, examples of which are illustrated in the appended drawings. The present disclosure may, however, be embodied in many different forms and should not be construed as being limited to the embodiments set forth herein.

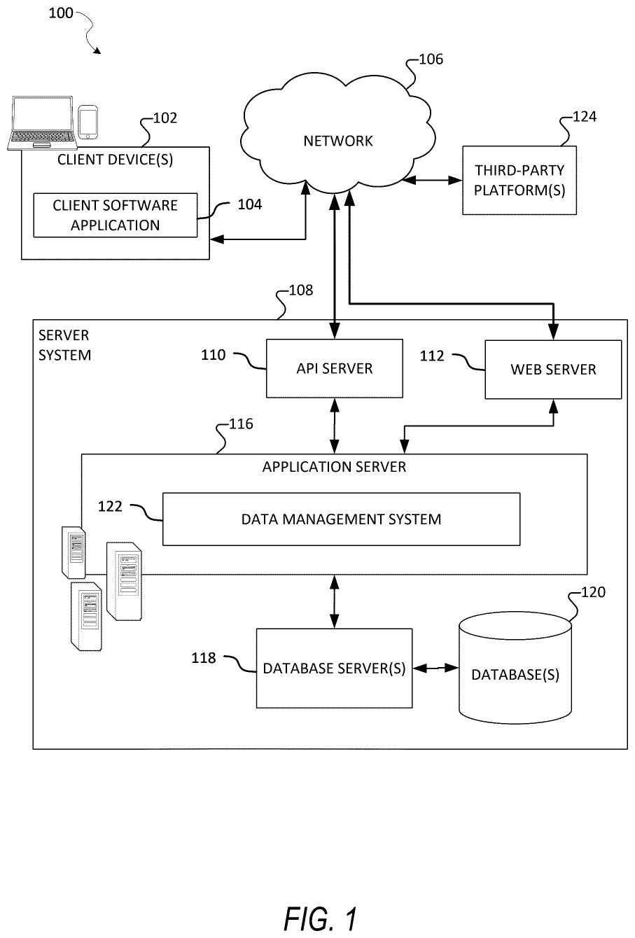

FIG. 1 is a block diagram showing an example data system 100 that includes a data management system 122 (also referred to as system 122), according to various embodiments of the present disclosure. By including the data management system 122, the data system 100 can facilitate machine learning model training using the LCA and the LSTA approaches. As shown, the data system 100 includes one or more client devices 102, a server system 108, and a network 106 (e.g., Internet, wide-area-network (WAN), local-area-network (LAN), wireless network) that communicatively couples them together. Each client device 102 can host a number of applications, including a client software application 104. The client software application 104 can communicate data with the server system 108 via a network 106. Accordingly, the client software application 104 can communicate and exchange data with the server system 108 via network 106.

The server system 108 provides server-side functionality via the network 106 to the client software application 104. While certain functions of the data system 100 are described herein as being performed by the data management system 122 on the server system 108, it will be appreciated that the location of certain functionality within the server system 108 is a design choice. For example, it may be technically preferable to initially deploy certain technology and functionality within the server system 108, but to later migrate this technology and functionality to the client software application 104.

The server system 108 supports various services and operations that are provided to the client software application 104 by the data management system 122. Such operations include transmitting data from the data management system 122 to the client software application 104, receiving data from the client software application 104 at the data management system 122, and the data management system 122 processing data generated by the client software application 104. Data exchanges within the data system 100 may be invoked and controlled through operations of software component environments available via one or more endpoints, or functions available via one or more user interfaces of the client software application 104, which may include web-based user interfaces provided by the server system 108 for presentation at the client device 102.

With respect to the server system 108, an Application Program Interface (API) server 110 and a web server 112 is coupled to an application server 116, which hosts the data management system 122. The application server 116 is communicatively coupled to a database server 118, which facilitates access to a database 120 that stores data associated with the application server 116, including data that may be generated or used by the data management system 122.

The API server 110 receives and transmits data (e.g., API calls, commands, requests, responses, and authentication data) between the client device 102 and the application server 116. Specifically, the API server 110 provides a set of interfaces (e.g., routines and protocols) that can be called or queried by the client software application 104 in order to invoke the functionality of the application server 116. The API server 110 exposes various functions supported by the application server 116 including, without limitation, user registration; login functionality; data object operations (e.g., generating, storing, retrieving, encrypting, decrypting, transferring, access rights, licensing); and/or user communications.

The server system 108, or the data management system 122 may extract user data from one or more third-party platforms (e.g., third-party social media platforms). The extracted data may be open-source poster data associated with targeted influencers on the one or more third-party platforms 124 and may include user profile data, activity data, and media posted (either created and/or shared) by the one or more influencers. The media (or media data) include text, image, video, audio, and metadata. Example metadata may include hashtags and labels.

Through one or more web-based interfaces (e.g., web-based user interfaces), the web server 112 can support various functionality of the data management system 122 of the application server 116.

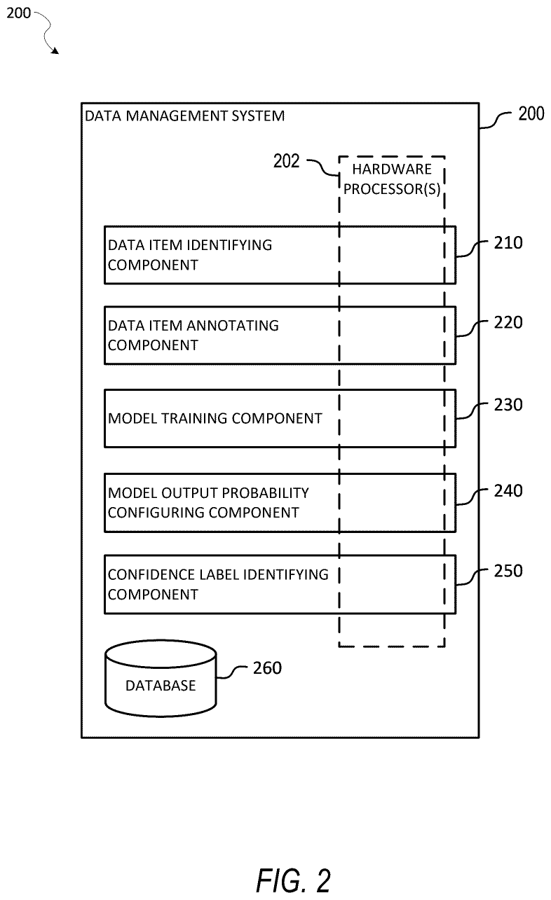

FIG. 2 is a block diagram illustrating an example data management system 200 that facilitates machine learning model training using the LCA and the LSTA approaches, according to various embodiments of the present disclosure. For some embodiments, the data management system 200 represents an example of the data management system 122 described with respect to FIG. 1. As shown, the data management system 200 comprises a data item identifying component 210, a data item annotating component 220, a model training component 230, a model output probability configuring component 240, and a confidence label identifying component 250. According to various embodiments, one or more of the data item identifying component 210, the data item annotating component 220, the model training component 230, the model output probability configuring component 240, and the confidence label identifying component 250 are implemented by one or more hardware processors 202. Data generated by one or more of the data item identifying component 210, the data item annotating component 220, the model training component 230, the model output probability configuring component 240, and the confidence label identifying component 250 may be stored in a database (or datastore) 260 of the data management system 200.

The data item identifying component 210 is configured to identify a plurality of data items associated with user-generated content. User-generated content can include one or more data items, such as reviews and comments.

The data item annotating component 220 is configured to use ML models to annotate the plurality of data items associated with user-generated content or a subset thereof. Annotation of data items results in model-generated labels. A label can describe a sentiment (e.g., positive, negative, neutral) of user-generated content associated with a respective data item (e.g., a product review or comment).

The model training component 230 is configured to train an ML model based on labels generated by other models or the model itself. The number of self-training rounds affects classification accuracy when using the self-training approach. Performing multiple rounds of self-training can enhance the model's performance.

The model output probability configuring component 240 is configured to determine a confidence value based on a plurality of example labels generated by a large-scale LLM with weights of more than 100 billion parameters. Based on the confidence value, the model output probability configuring component 240 is configured to determine the model output probability that helps guide the subsequent model training.

Based on the determined model output probability, the confidence label identifying component 250 is configured to identify one or more confidence labels from model-generated labels. High-confidence labels (>0.9) may be selected to fine-tune other models or the model itself.

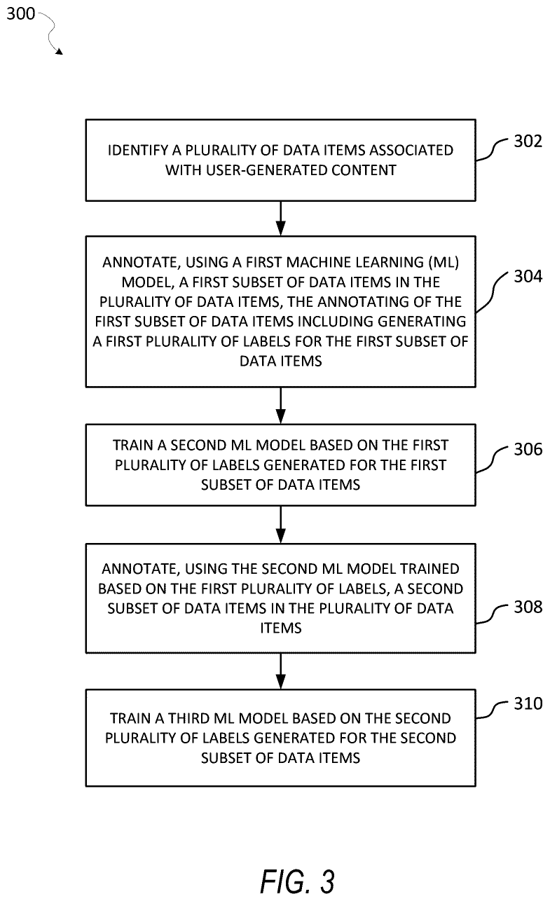

FIG. 3 is a flowchart illustrating an example method 300 for facilitating machine learning model training using a cascade of models for knowledge distillation, according to various embodiments of the present disclosure. It will be understood that example methods described herein may be performed by a machine in accordance with some embodiments. For example, method 300 can be performed by the data management system 122 described with respect to FIG. 1, the data management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 300 may be represented by executable instructions that, when executed by a processor of a computing device, cause the computing device to perform method 300. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel.

At operation 302, a processor identifies a plurality of data items associated with user-generated content. For example, user-generated content can include one or more data items, such as reviews and comments.

At operation 304, a processor annotates, using a machine learning (ML) model (e.g., the first ML model), a subset of data items (e.g., the first subset of data items) in the plurality of data items. An example of the first ML model can be a large-scale Large Language Model (LLM) with weights of more than 100 billion parameters. The plurality of data items associated with user-generated content can include one or more of a plurality of comments and a plurality of reviews. The operation of annotating the subset of data items can include generating a plurality of labels (e.g., the first plurality of labels) for the subset of data items (e.g., the first subset of data items). Each label can describe a sentiment (e.g., positive, negative, neutral) of user-generated content associated with a respective data item (e.g., a product review or comment). In various embodiments, a sentiment of user-generated content corresponds to a model output value representing positive, negative, or neutral.

At operation 306, a processor trains a second ML model based on the first plurality of labels generated for the first subset of data items. The second ML model can be a medium-scale Large Language Model (LLM) with weights between 1 billion parameters and 100 billion parameters.

At operation 308, a processor annotates, using the second ML model trained based on the first plurality of labels, a second subset of data items in the plurality of data items. The operation of annotating the second subset of data items can include the operation of generating a second plurality of labels for the second subset of data items. Compared to the first subset of data items (e.g., 500 examples), the second subset of data items can include a significant portion (or the remaining portion) of the unlabeled datasets. For example, the significant portion (or the remaining portion) can include 25,000 examples.

At operation 310, a processor trains a third ML model based on the second plurality of labels generated by the second ML model. The third ML model can be a small-scale, production-friendly Large Language Model (LLM) having weights of less than 1 billion parameters. An example of the third ML model is Bidirectional Encoder Representations from Transformers (BERT). BERT is a small, production-friendly model that helps avoid significant constraints related to scale and costs.

Though not illustrated, method 300 can include an operation where a graphical user interface is displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 302 through 310 or, alternatively, form part of one or more of operations 302 through 310.

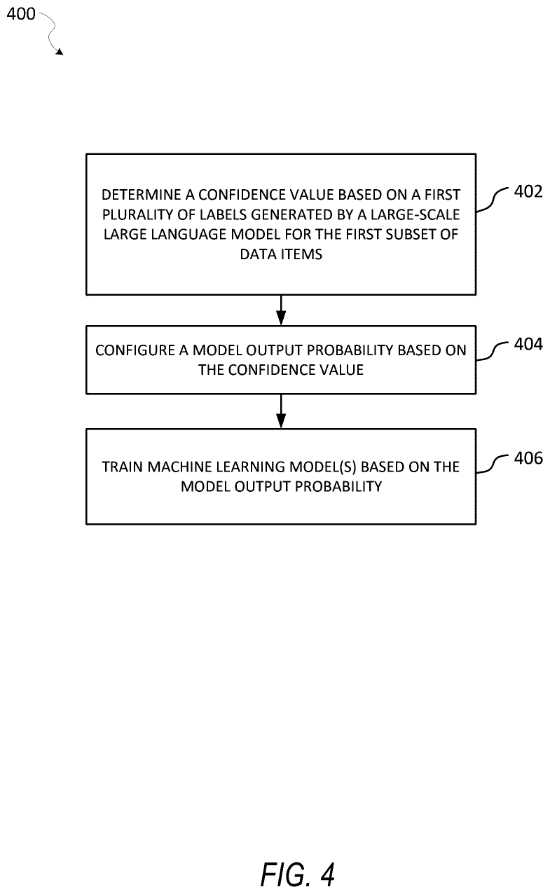

FIG. 4 is a flowchart illustrating an example method 400 for facilitating machine learning model training using a cascade of models for knowledge distillation, according to various embodiments of the present disclosure. It will be understood that example methods described herein may be performed by a machine in accordance with some embodiments. For example, method 400 can be performed by the data management system 122 described with respect to FIG. 1, the data management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 400 may be represented by executable instructions that, when executed by a processor of a computing device, cause the computing device to perform method 400. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel. Operations in method 400 can be performed dependently or independently from operations in method 300.

At operation 402, a processor identifies (or determines) a confidence value based on the first plurality of labels generated by the large-scale LLM. The confidence value represents the accuracy of annotation for the first subset of data items.

At operation 404, a processor configures (or determines) the model output probability based on the confidence value.

At operation 406, a processor trains medium-scale LLMs (e.g., the second ML model) and small-scale LLMs (e.g., the third ML model) based on the model output probability. For example, the accuracy of the annotation (large-scale LLM's model outputs) for the first subset of data items is determined to be 97%, corresponding to a confidence value (also referred to as a model output probability) of 0.97. It indicates that 97% of labels generated for the first subset of data items are accurately determined (e.g., following the instructions given to the model). Such a percentage of accuracy can be used as a training goal in the subsequent training of medium-scale and small-scale LLMs.

Though not illustrated, method 400 can include an operation where a graphical user interface can be displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 402 through 406 or, alternatively, form part of one or more of operations 402 through 406.

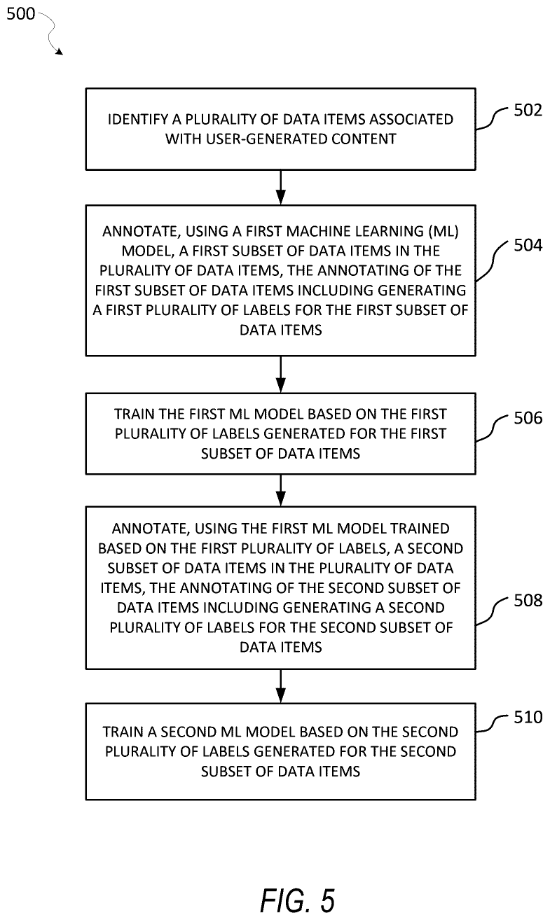

FIG. 5 is a flowchart illustrating an example method 500 for facilitating machine learning model training using a self-training approach, according to various embodiments of the present disclosure. It will be understood that example methods described herein may be performed by a machine in accordance with some embodiments. For example, method 500 can be performed by the data management system 122 described with respect to FIG. 1, the data management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 500 may be represented by executable instructions that, when executed by a processor of a computing device, cause the computing device to perform method 500. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel.

At operation 502, a processor identifies a plurality of data items associated with user-generated content. For example, user-generated content can include one or more data items, such as reviews and comments.

At operation 504, a processor annotates, using a machine learning (ML) model (e.g., the first ML model), a subset of data items (e.g., the first subset of data items) in the plurality of data items. An example of the first ML model is a medium-scale Large Language Model (LLM) with weights between 1 billion and 100 billion parameters. The plurality of data items associated with user-generated content can include one or more of a plurality of comments and a plurality of reviews. The operation of annotating the subset of data items can include generating a plurality of labels (e.g., the first plurality of labels) for the subset of data items (e.g., the first subset of data items). Each label can describe a sentiment (e.g., positive, negative, neutral) of user-generated content associated with a respective data item (e.g., a product review or comment). In various embodiments, a sentiment of user-generated content corresponds to a model output value representing positive, negative, or neutral.

At operation 506, a processor trains the medium-scale LLM (e.g., the first ML model) based on the first plurality of labels generated for the first subset of data items. The training can be performed in multiple rounds to improve model performance. This LSTA approach leverages the self-supervision techniques and capabilities of the medium-scale LLM (e.g., the first ML model) to self-train using labels generated by itself.

At operation 508, a processor uses the medium-scale LLM trained based on the first plurality of labels generated by itself to annotate a second subset of data items in the plurality of data items. The operation of annotating the second subset of data items includes generating a second plurality of labels for the second subset of data items.

At operation 510, a processor trains a small-scale production-friendly model (e.g., the second ML model) based on the second plurality of labels generated for the second subset of data items. The second ML model can be a small-scale, production-friendly LLM with weights of less than 1 billion parameters. An example of the second ML model is Bidirectional Encoder Representations from Transformers (BERT). BERT is a small, production-friendly model that helps avoid significant constraints related to scale and costs.

Though not illustrated, method 500 can include an operation where a graphical user interface can be displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 502 through 510 or, alternatively, form part of one or more of operations 502 through 510.

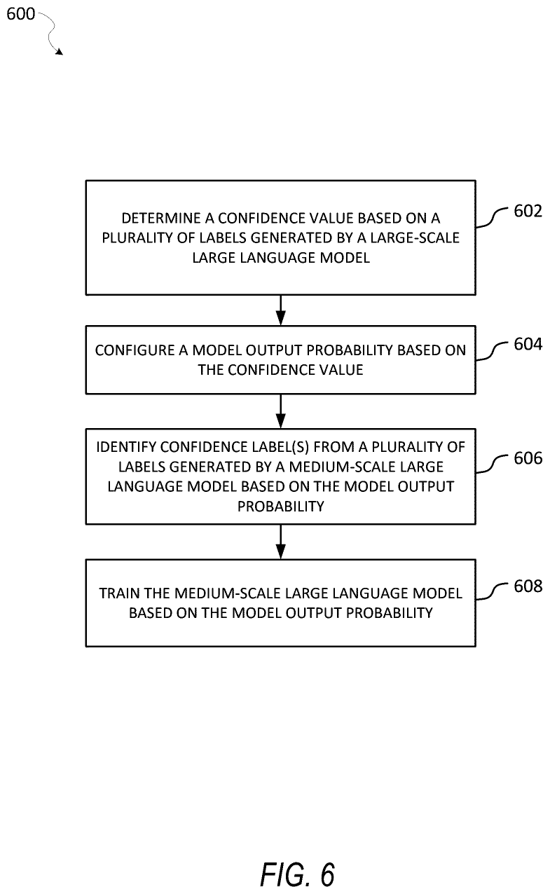

FIG. 6 is a flowchart illustrating an example method 600 for facilitating machine learning model training using a self-training approach, according to various embodiments of the present disclosure. It will be understood that example methods described herein may be performed by a machine in accordance with some embodiments. For example, method 600 can be performed by the data management system 122 described with respect to FIG. 1, the data management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 600 may be represented by executable instructions that, when executed by a processor of a computing device, cause the computing device to perform method 600. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel.

At operation 602, a processor determines a confidence value based on a plurality of example labels generated by a large-scale large language model with weights of more than 100 billion parameters.

Based on the confidence value, at operation 604, a processor determines (or configures) the model output probability.

At operation 606, a processor identifies one or more confidence labels from the first plurality of labels based on the determined model output probability.

At operation 608, a processor trains the medium-scale LLM (e.g., the first ML model) based on the one or more confidence labels associated with user-generated content. This approach improves the labeling quality by selecting high-confidence labels based on the model output probabilities. Those selected high-confidence pseudo-labels (>0.9) generated by the medium-scale LLM are used to fine-tune the model itself. This self-training process can be repeated as needed. The self-trained medium-scale LLM is then used to generate the final pseudo-labels to train the small-scale production-friendly model (e.g., the second ML model).

Though not illustrated, method 600 can include an operation where a graphical user interface can be displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 602 through 608 or, alternatively, form part of one or more of operations 602 through 608.

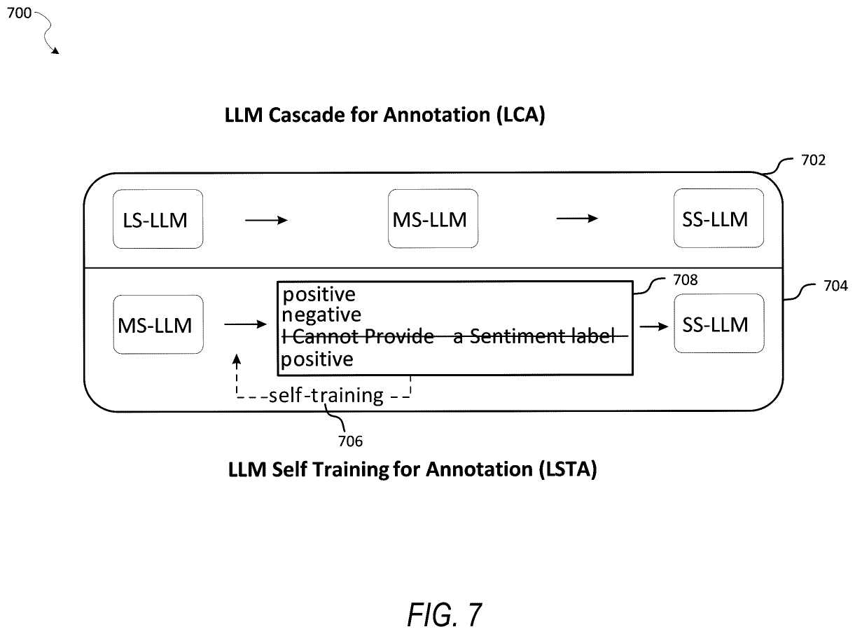

FIG. 7 is a diagram illustrating data flow 700 within an example data management system that facilitates machine learning model training using the LCA and the LSTA approaches, according to various embodiments of the present disclosure. As shown, the upper pathway 702 illustrates the LCA approach that allows knowledge distillation from a large-scale LLM (e.g., LS-LLM) to a medium-scale LLM (e.g., MS-LLM) followed by a small-scale production-friendly LLM (e.g., SS-LLM, such as BERT). The lower pathway 704 demonstrates the LSTA approach, where a medium-scale LLM leads to small-scale LLM distillation. The lower pathway 704 illustrates an iterative refinement stage 706 utilizing pseudo-labels 708 for model performance improvement.

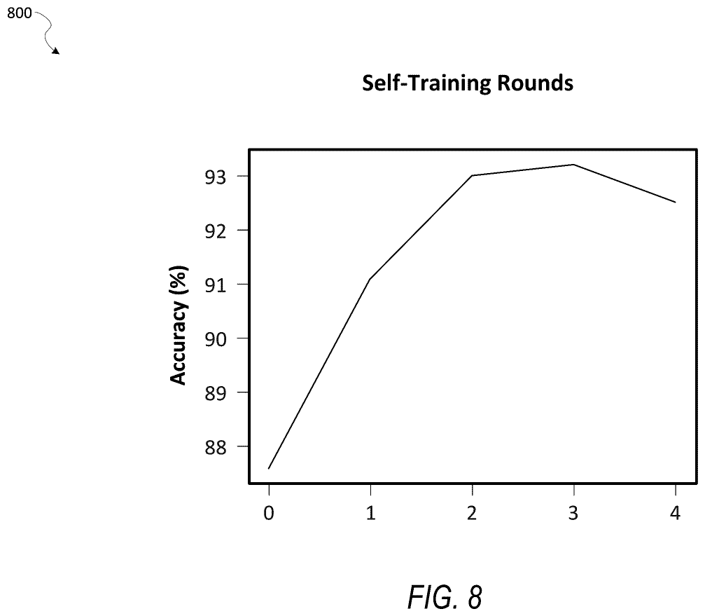

FIG. 8 is a diagram illustrating a line graph representing model output accuracy in relation to self-training rounds using the LSTA approach, according to various embodiments of the present disclosure. As shown, after two rounds of medium-scale LLM self-training under the LSTA approach using 500 training samples, performance did not significantly improve, and even a minor decrease was observed after the fourth round of self-training.

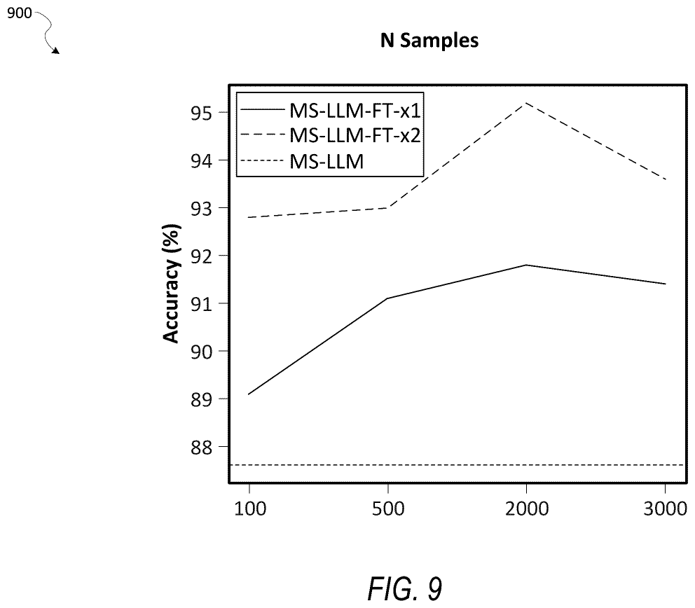

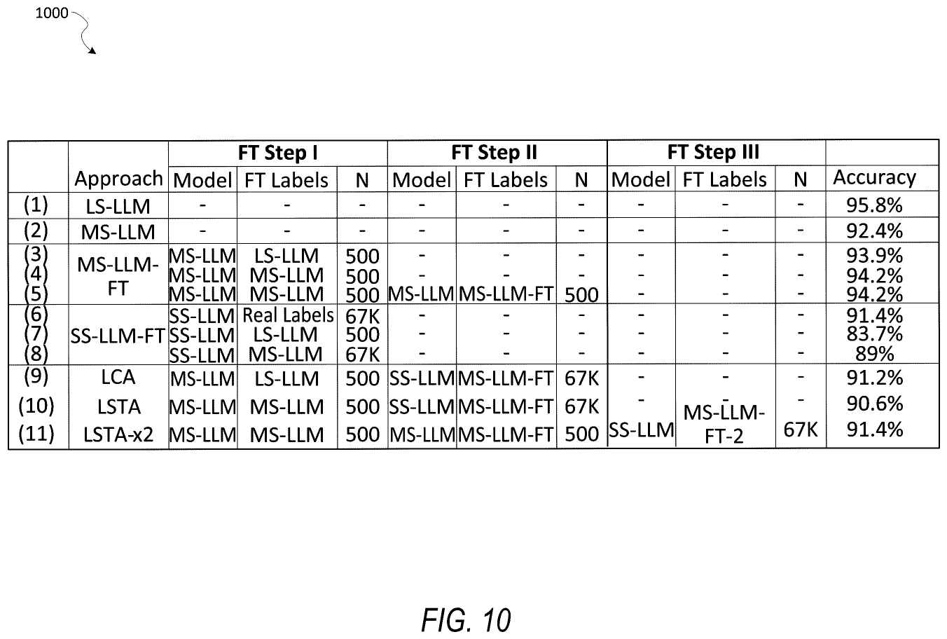

FIG. 9 is a diagram illustrating a line graph representing model output accuracy in relation to the size of training samples under the LSTA approach, according to various embodiments of the present disclosure. As shown, enhancing the model's performance is achievable by increasing the number of samples (e.g., data items) up to a certain number (e.g., 2000), and this holds true for both the first and the second rounds of self-training. However, no additional improvement was observed using more samples beyond 2000. Considering the high performance of a medium-scale LLM with 2000 samples and two rounds of self-training (achieving an accuracy of 95.2%), the effects of fine-tuning a BERT student model are examined using pseudo-labels generated by the finely-tuned medium-scale LLM. As anticipated, the performance of the BERT model improved as well, reaching an accuracy of 92.6%. This is even higher than the results obtained when using the LCA approach, which achieved an accuracy of 91.2% (as illustrated in FIG. 10, row 9). When applying LSTA to a different medium-scale LLM, the pre-trained medium-scale LLM shows an accuracy of 90% for the same training sample. After a single round of fine-tuning, using 500 pseudo-labels generated by the pre-trained medium-scale LLM, the accuracy increased to 93.4%. This demonstrates the efficacy of the LSTA approach in enhancing model performance.

FIG. 10 is a diagram illustrating the comparative performance statistics of the LCA and the LSTA approaches, according to various embodiments of the present disclosure. “FT labels” refer to labels used for fine-tuning. LS-LLM refers to large-scale LLM. MS-LLM refers to medium-scale LLM. SS-LLM refers to small-scale LLM. MS-LLM-FT refers to a fine-tuned (or trained) MS-LLM. MS-LLM-FT-2 labels refer to labels generated by an MS-LLM fine-tuned in step II. MS-LLM-FT-2 labels in step III refer to labels generated by a MS-LLM fine-tuned twice in step II. A fine-tuned model and a trained model are used interchangeably, as discussed herein.

As illustrated in FIG. 10, in row 1, the accuracy of data annotation by a large-scale LLM is 95.8%. In row 2, the accuracy of data annotation by a medium-scale LLM is 92.4%. In row 9, using the LCA approach, 500 pseudo-labels (or samples) generated by a large-scale LLM are used to train a medium-scale LLM in step I. 67k pseudo-labels generated by the fine-tuned medium-scale LLM are used to train a small-scale LLM. The accuracy of data annotation by the fine-tuned small-scale LLM reaches 91.2%. In row 10, using the LSTA approach, 500 pseudo-labels generated by a medium-scale LLM are used to train the medium-scale LLM itself in step I, leveraging the self-training capabilities of the medium-scale LLM. 67k pseudo-labels generated by the fine-tuned medium-scale LLM are used to train a small-scale LLM. The accuracy of data annotation by the fine-tuned small-scale LLM reaches 90.6%. However, after a second round of LSTA training (medium-scale LLM being trained twice using the self-training approach), in row 11, the accuracy of data annotation by the fine-tuned small-scale LLM reaches 91.4%, showing a performance improvement compared to the fine-tuned small-scale LLM with one round of training for the medium-scale LLM.

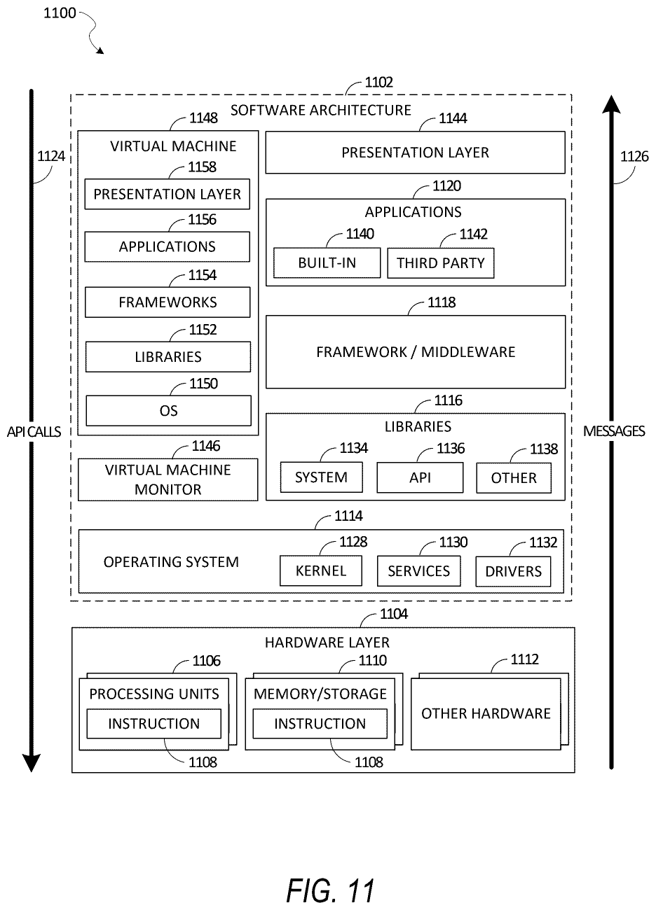

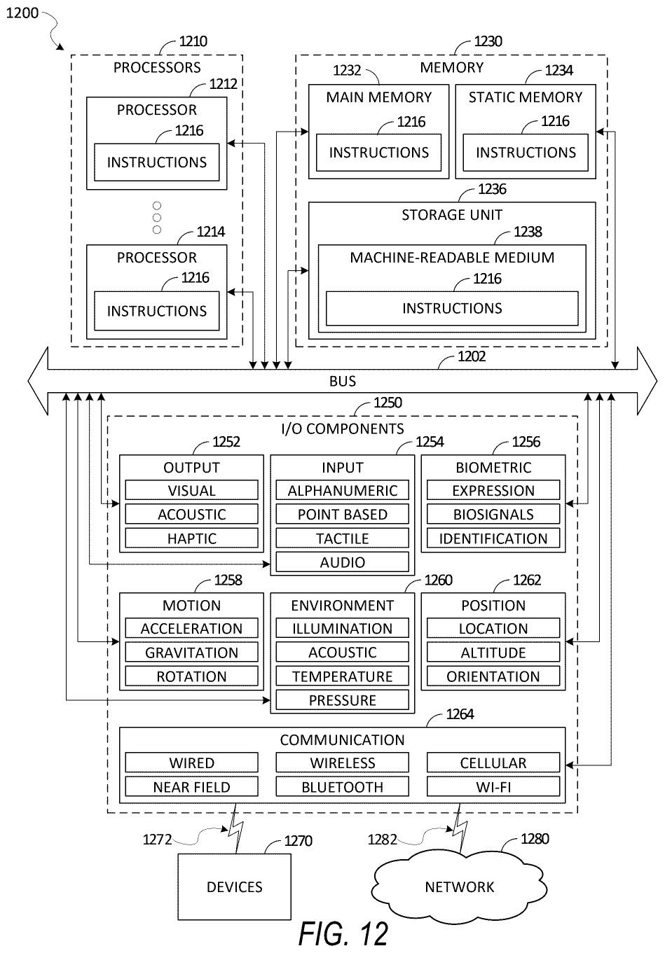

FIG. 11 is a block diagram illustrating an example of a software architecture 1102 that may be installed on a machine, according to some example embodiments. FIG. 11 is merely a non-limiting example of a software architecture, and it will be appreciated that many other architectures may be implemented to facilitate the functionality described herein. The software architecture 1102 may be executing on hardware such as a machine 1200 of FIG. 12 that includes, among other things, processors 1210, memory 1230, and input/output (I/O) components 1250. A representative hardware layer 1104 is illustrated and can represent, for example, the machine 1200 of FIG. 12. The representative hardware layer 1104 comprises one or more processing units 1106 having associated executable instructions 1108. The executable instructions 1108 represent the executable instructions of the software architecture 1102. The hardware layer 1104 also includes memory or storage modules 1110, which also have the executable instructions 1108. The hardware layer 1104 may also comprise other hardware 1112, which represents any other hardware of the hardware layer 1104, such as the other hardware illustrated as part of the machine 1200.

In the example architecture of FIG. 11, the software architecture 1102 may be conceptualized as a stack of layers, where each layer provides particular functionality.

For example, the software architecture 1102 may include layers such as an operating system 1114, libraries 1116, frameworks/middleware 1118, applications 1120, and a presentation layer 1144. Operationally, the applications 1120 or other components within the layers may invoke API calls 1124 through the software stack and receive a response, returned values, and so forth (illustrated as messages 1126) in response to the API calls 1124. The layers illustrated are representative in nature, and not all software architectures have all layers. For example, some mobile or special-purpose operating systems may not provide a frameworks/middleware 1118 layer, while others may provide such a layer. Other software architectures may include additional or different layers.

The operating system 1114 may manage hardware resources and provide common services. The operating system 1114 may include, for example, a kernel 1128, services 1130, and drivers 1132. The kernel 1128 may act as an abstraction layer between the hardware and the other software layers. For example, the kernel 1128 may be responsible for memory management, processor management (e.g., scheduling), component management, networking, security settings, and so on. The services 1130 may provide other common services for the other software layers. The drivers 1132 may be responsible for controlling or interfacing with the underlying hardware. For instance, the drivers 1132 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1116 may provide a common infrastructure that may be utilized by the applications 1120 and/or other components and/or layers. The libraries 1116 typically provide functionality that allows other software modules to perform tasks in an easier fashion than by interfacing directly with the underlying operating system 1114 functionality (e.g., kernel 1128, services 1130, or drivers 1132). The libraries 1116 may include system libraries 1134 (e.g., C standard library) that may provide functions such as memory allocation functions, string manipulation functions, mathematic functions, and the like. In addition, the libraries 1116 may include API libraries 1136 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1116 may also include a wide variety of other libraries 1138 to provide many other APIs to the applications 1120 and other software components/modules.

The frameworks 1118 (also sometimes referred to as middleware) may provide a higher-level common infrastructure that may be utilized by the applications 1120 or other software components/modules. For example, the frameworks 1118 may provide various graphical user interface functions, high-level resource management, high-level location services, and so forth. The frameworks 1118 may provide a broad spectrum of other APIs that may be utilized by the applications 1120 and/or other software components/modules, some of which may be specific to a particular operating system or platform.

The applications 1120 include built-in applications 1140 and/or third-party applications 1142. Examples of representative built-in applications 1140 may include, but are not limited to, a home application, a contacts application, a browser application, a book reader application, a location application, a media application, a messaging application, or a game application.

The third-party applications 1142 may include any of the built-in applications 1140, as well as a broad assortment of other applications. In a specific example, the third-party applications 1142 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 1142 may invoke the API calls 1124 provided by the mobile operating system such as the operating system 1114 to facilitate functionality described herein.

The applications 1120 may utilize built-in operating system functions (e.g., kernel 1128, services 1130, or drivers 1132), libraries (e.g., system libraries 1134, API libraries 1136, and other libraries 1138), or frameworks/middleware 1118 to create user interfaces to interact with users of the system. Alternatively, or additionally, in some systems, interactions with a user may occur through a presentation layer, such as the presentation layer 1144. In these systems, the application/module “logic” can be separated from the aspects of the application/module that interact with the user.

Some software architectures utilize virtual machines. In the example of FIG. 11, this is illustrated by a virtual machine 1148. The virtual machine 1148 creates a software environment where applications/modules can execute as if they were executing on a hardware machine (e.g., the machine 800 of FIG. 8). The virtual machine 1148 is hosted by a host operating system (e.g., the operating system 1114) and typically, although not always, has a virtual machine monitor 1146, which manages the operation of the virtual machine 1148 as well as the interface with the host operating system (e.g., the operating system 1114). A software architecture executes within the virtual machine 1148, such as an operating system 1150, libraries 1152, frameworks 1154, applications 1156, or a presentation layer 1158. These layers of software architecture executing within the virtual machine 1148 can be the same as corresponding layers previously described or may be different.

FIG. 12 illustrates a diagrammatic representation of a machine 1200 in the form of a computer system within which a set of instructions may be executed for causing the machine 1200 to perform any one or more of the methodologies discussed herein, according to an embodiment. Specifically, FIG. 12 shows a diagrammatic representation of the machine 1200 in the example form of a computer system, within which instructions 1216 (e.g., software, a program, an application, an applet, an app, or other executable code) for causing the machine 1200 to perform any one or more of the methodologies discussed herein may be executed. For example, the instructions 1216 may cause the machine 1200 to execute the method 300 described above with respect to FIG. 3 and the method 400 described above with respect to FIG. 4. The instructions 1216 transform the general, non-programmed machine 1200 into a particular machine 1200 programmed to carry out the described and illustrated functions in the manner described. In alternative embodiments, the machine 1200 operates as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, or any machine capable of executing the instructions 1216, sequentially or otherwise, that specify actions to be taken by the machine 1200. Further, while only a single machine 1200 is illustrated, the term “machine” shall also be taken to include a collection of machines 1200 that individually or jointly execute the instructions 1216 to perform any one or more of the methodologies discussed herein.

The machine 1200 may include processors 1210, memory 1230, and I/O components 1250, which may be configured to communicate with each other such as via a bus 1202. In an embodiment, the processors 1210 (e.g., a hardware processor, such as a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1212 and a processor 1214 that may execute the instructions 1216. The term “processor” is intended to include multi-core processors that may comprise two or more independent processors (sometimes referred to as “cores”) that may execute instructions contemporaneously. Although FIG. 12 shows multiple processors 1210, the machine 1200 may include a single processor with a single core, a single processor with multiple cores (e.g., a multi-core processor), multiple processors with a single core, multiple processors with multiples cores, or any combination thereof.

The memory 1230 may include a main memory 1232, a static memory 1234, and a storage unit 1236 including machine-readable medium 1238, each accessible to the processors 1210 such as via the bus 1202. The main memory 1232, the static memory 1234, and the storage unit 1236 store the instructions 1216 embodying any one or more of the methodologies or functions described herein. The instructions 1216 may also reside, completely or partially, within the main memory 1232, within the static memory 1234, within the storage unit 1236, within at least one of the processors 1210 (e.g., within the processor's cache memory), or any suitable combination thereof, during execution thereof by the machine 1200.

The I/O components 1250 may include a wide variety of components to receive input, provide output, produce output, transmit information, exchange information, capture measurements, and so on. The specific I/O components 1250 that are included in a particular machine will depend on the type of machine. For example, portable machines such as mobile phones will likely include a touch input device or other such input mechanisms, while a headless server machine will likely not include such a touch input device. It will be appreciated that the I/O components 1250 may include many other components that are not shown in FIG. 12. The I/O components 1250 are grouped according to functionality merely for simplifying the following discussion, and the grouping is in no way limiting. In some examples, the I/O components 1250 may include output components 1252 and input components 1254. The output components 1252 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1254 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further embodiments, the I/O components 1250 may include biometric components 1256, motion components 1258, environmental components 1260, or position components 1262, among a wide array of other components. The motion components 1258 may include acceleration sensor components (e.g., accelerometer), gravitation sensor components, rotation sensor components (e.g., gyroscope), and so forth. The environmental components 1260 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1262 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1250 may include communication components 1264 operable to couple the machine 1200 to a network 1280 or devices 1270 via a coupling 1282 and a coupling 1272, respectively. For example, the communication components 1264 may include a network interface component or another suitable device to interface with the network 1280. In further examples, the communication components 1264 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1270 may be another machine or any of a wide variety of peripheral devices (e.g., a peripheral device coupled via a USB).

Moreover, the communication components 1264 may detect identifiers or include components operable to detect identifiers. For example, the communication components 1264 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1264, such as location via Internet Protocol (IP) geolocation, location via Wi-Fi® signal triangulation, location via detecting an NFC beacon signal that may indicate a particular location, and so forth.

Certain embodiments are described herein as including logic or a number of components, modules, elements, or mechanisms. Such modules can constitute either software modules (e.g., code embodied on a machine-readable medium or in a transmission signal) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) are configured by software (e.g., an application or application portion) as a hardware module that operates to perform certain operations as described herein.

In some examples, a hardware module is implemented mechanically, electronically, or any suitable combination thereof. For example, a hardware module can include dedicated circuitry or logic that is permanently configured to perform certain operations. For example, a hardware module can be a special-purpose processor, such as a field-programmable gate array (FPGA) or an ASIC. A hardware module may also include programmable logic or circuitry that is temporarily configured by software to perform certain operations. For example, a hardware module can include software encompassed within a general-purpose processor or other programmable processor. It will be appreciated that the decision to implement a hardware module mechanically, in dedicated and permanently configured circuitry, or in temporarily configured circuitry (e.g., configured by software) can be driven by cost and time considerations.

Accordingly, the phrase “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software can accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between or among such hardware modules may be achieved, for example, through the storage and retrieval of information in memory structures to which the multiple hardware modules have access. For example, one hardware module performs an operation and stores the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines 1200 including processors 1210), with these operations being accessible via a network (e.g., the Internet) and via one or more appropriate interfaces (e.g., an API). In certain embodiments, for example, a client device may relay or operate in communication with cloud computing systems and may access circuit design information in a cloud environment.

The performance of certain of the operations may be distributed among the processors, not only residing within a single machine 1200, but deployed across a number of machines 1200. In some example embodiments, the processors 1210 or processor-implemented modules are located in a single geographic location (e.g., within a home environment, an office environment, or a server farm). In other example embodiments, the processors or processor-implemented modules are distributed across a number of geographic locations.

The various memories (i.e., 1230, 1232, 1234, and/or the memory of the processor(s) 1210) and/or the storage unit 1236 may store one or more sets of instructions 1216 and data structures (e.g., software) embodying or utilized by any one or more of the methodologies or functions described herein. These instructions (e.g., the instructions 1216), when executed by the processor(s) 1210, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 1216 and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In some examples, one or more portions of the network 1280 may be an ad hoc network, an intranet, an extranet, a virtual private network (VPN), a LAN, a wireless LAN (WLAN), a WAN, a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1280 or a portion of the network 1280 may include a wireless or cellular network, and the coupling 1282 may be a Code Division Multiple Access (CDMA) connection, a Global System for Mobile communications (GSM) connection, or another type of cellular or wireless coupling. In this example, the coupling 1282 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions may be transmitted or received over the network using a transmission medium via a network interface device (e.g., a network interface component included in the communication components) and utilizing any one of a number of well-known transfer protocols (e.g., hypertext transfer protocol (HTTP)). Similarly, the instructions may be transmitted or received using a transmission medium via the coupling (e.g., a peer-to-peer coupling) to the devices 1270. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals. For instance, an embodiment described herein can be implemented using a non-transitory medium (e.g., a non-transitory computer-readable medium).

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A system comprising:
one or more hardware processors; and
at least one machine-storage medium for storing instructions that, when executed by the one or more hardware processors, cause the one or more hardware processors to perform operations comprising:
identifying a plurality of data items associated with user-generated content;
annotating, using a first machine learning (ML) model, a first subset of data items in the plurality of data items, the annotating of the first subset of data items comprising generating a first plurality of labels for the first subset of data items, each label describing a sentiment of user-generated content associated with a respective data item;
training the first ML model based on the first plurality of labels generated for the first subset of data items;
annotating, using the trained first ML model, a second subset of data items in the plurality of data items, the annotating of the second subset of data items comprising generating a second plurality of labels for the second subset of data items; and
training a second ML model based on the second plurality of labels generated for the second subset of data items.

2. The system of claim 1, wherein the first ML model comprises a medium-scale Large Language Model having weights between 1 billion parameters and 100 billion parameters.

3. The system of claim 1, wherein the second ML model comprises a small-scale Large Language Model having weights of less than 1 billion parameters.

4. The system of claim 1, wherein the operations comprise:
identifying one or more confidence labels from the first plurality of labels based on a model output probability; and
training the first ML model based on the one or more confidence labels and user-generated content.

5. The system of claim 4, wherein the operations comprise:
determining a confidence value based on a plurality of example labels generated by a large-scale Large Language Model having weights of more than 100 billion parameters; and
configuring the model output probability based on the confidence value.

6. The system of claim 5, wherein the confidence value represents an accuracy of annotation for the first subset of data items.

7. The system of claim 5, wherein the operations comprise:
identifying one or more confidence labels from the second plurality of labels based on the model output probability; and
training the first ML model based on the one or more confidence labels.

8. The system of claim 7, wherein the model output probability is a first model output probability, and wherein the operations comprise:
determining the one or more confidence labels corresponds to a second model output probability below the first model output probability; and
training of the first ML model based on the one or more confidence labels from the second plurality of labels.

9. The system of claim 1, wherein the sentiment of user-generated content corresponds to a model output value representing positive, negative, or neutral.

10. The system of claim 1, wherein the plurality of data items associated with user-generated content comprises one or more of a plurality of comments and a plurality of reviews.

11. A method comprising:
identifying a plurality of data items associated with user-generated content;
annotating, using a first machine learning (ML) model, a first subset of data items in the plurality of data items, the annotating of the first subset of data items comprising generating a first plurality of labels for the first subset of data items, each label describing a sentiment of user-generated content associated with a respective data item;
training the first ML model based on the first plurality of labels generated for the first subset of data items;
annotating, using the trained first ML model, a second subset of data items in the plurality of data items, the annotating of the second subset of data items comprising generating a second plurality of labels for the second subset of data items; and
training a second ML model based on the second plurality of labels generated for the second subset of data items.

12. The method of claim 11, wherein the first ML model comprises a medium-scale Large Language Model having weights between 1 billion parameters and 100 billion parameters.

13. The method of claim 11, wherein the second ML model comprises a small-scale Large Language Model having weights of less than 1 billion parameters.

14. The method of claim 11, comprising:
identifying one or more confidence labels from the first plurality of labels based on a model output probability; and
training the first ML model based on the one or more confidence labels and user-generated content.

15. The method of claim 14, comprising:
determining a confidence value based on a plurality of example labels generated by a large-scale Large Language Model having weights of more than 100 billion parameters; and
configuring the model output probability based on the confidence value.

16. The method of claim 15, wherein the confidence value represents an accuracy of annotation for the first subset of data items.

17. The method of claim 15, comprising:
identifying one or more confidence labels from the second plurality of labels based on the model output probability; and
training the first ML model based on the one or more confidence labels.

18. The method of claim 17, wherein the model output probability is a first model output probability, comprising:
determining the one or more confidence labels corresponds to a second model output probability below the first model output probability; and
training of the first ML model based on the one or more confidence labels from the second plurality of labels.

19. The method of claim 11, wherein the sentiment of user-generated content corresponds to a model output value representing positive, negative, or neutral.

20. A machine-storage medium for storing instructions that, when executed by one or more hardware processors, cause the one or more hardware processors to perform operations comprising:
identifying a plurality of data items associated with user-generated content;
annotating, using a first machine learning (ML) model, a first subset of data items in the plurality of data items, the annotating of the first subset of data items comprising generating a first plurality of labels for the first subset of data items, each label describing a sentiment of user-generated content associated with a respective data item;
training the first ML model based on the first plurality of labels generated for the first subset of data items;
annotating, using the trained first ML model, a second subset of data items in the plurality of data items, the annotating of the second subset of data items comprising generating a second plurality of labels for the second subset of data items; and
training a second ML model based on the second plurality of labels generated for the second subset of data items.
